(19) United States
(12) Patent Application Publication
(10) Pub. No.: US 2009/0135080 A1
(43) Pub. Date: May 28, 2009

(54) Magnetc radiator arranged with decoupling means

(75) Inventors: Pieter Benthem, Meppel (NL); Johan Booij, Hoogeveen (NL); Frans Philip Schreuder, Groningen (NL); Johan Marinus Vissia, Tubbergen (NL)

Correspondence Address: MICHAELSON & ASSOCIATES, P.O. BOX 8489, RED BANK, NJ, 07701-8489, US

(73) Assignee: Stichting ASTRON, Dwingeloo (NL)

(21) Appl. No.: 12/315,192

(22) Filed: Nov. 28, 2008

Related U.S. Application Data
(60) Provisional application No. 61/004,600, filed on Nov. 28, 2007.

(51) Int. Cl. H01Q 1/52

(52) U.S. Cl. 343/851

(57) ABSTRACT

A portal article detection means (10, 20) having a plurality of radiator elements (1, 2, 3, L₁, L₂, L₃) for generating a magnetic field (B), wherein the magnetic radiator further comprises an electronic component (−L₁₂, −L₂₃, −L₁₃) arranged in electrical connection between said radiator elements for substantially decoupling the radiator elements (L₁, L₂, L₃).

### CLAIM TO PRIORITY

This application claims priority of our co-pending U.S. provisional patent application entitled “A Magnetic Radiator arranged with Decoupling Means”, filed on Nov. 28, 2007 and assigned Ser. No. 61/004,600; and which is incorporated by reference herein.

### BACKGROUND OF THE INVENTION

1. Field of the Invention

The invention relates to portal article detection means.

2. Description of the Prior Art

Portal article detection means are known per se. For example, they are contemporary used in many department stores and usually comprise multiple magnetic radiators arranged in each other's vicinity, for example multiple exit ports. The magnetic radiator may be composed of a suitable plurality of radiator elements, which may be used to provide a single detection port bar, wherein said radiator elements are arranged consecutively, for example in a vertical order. The radiator elements generate respective magnetic fields. A magnetic field generated by a first radiator element will induce voltage in other radiator elements positioned in its vicinity. This means phase of the other radiator elements will be influenced in such a way that, for example, the phase will be equal and/or opposite to the phase of the first radiator element. Preferably, the phase of the radiator element is defined by the radiator elements source.

Also, the amplitude will be influenced in such a way that, for example, the amplitude will increase and/or decrease compared to the desired value defined by the radiator elements source.

However, it may be desirable to control radiator elements separately, for example to alter phase and the amplitude of one radiator element without altering radiation parameters of the other radiator elements.

It is a disadvantage of the known radiator elements that mutual coupling of radiator elements constituting a magnetic radiator of a portal article detection means can make it impossible to control the radiator elements separately. More particularly, if the magnetic radiators are in resonance on a certain frequency, the mutual coupling may alter the resonance frequency into multiple resonant frequencies, which is undesirable. This is undesirable because it is important to control each radiator element separately, in such a way that radiator elements positioned in each other's vicinity have a minimal influence on an individual resonance frequency of each radiator element constituting the magnetic radiator.

### SUMMARY OF THE INVENTION

It is an object of the invention to provide a portal article detection means comprising a plurality of radiator element circuits, wherein said plurality of radiator elements may be individually controlled.

To this end, the portal article detection means according to the invention comprises an electronic component arranged in electrical connection between said radiator element circuits for substantially decoupling the radiator elements in the same frequency range.

The technical measure of the invention is based on the following insights, which shall be explained with respect to an equivalent circuit of a magnetic radiator circuit comprising three radiator elements implemented as three inductors L₁, L₂, L₃.

It will be appreciated that the inventive insight are applicable to any number of inductors. If the coupling factor between two certain radiator elements is negative, the equivalent inductance Lᵢⱼ will have a negative value too. A similar effect can be created by altering the polarity of the radiator elements. If one of the elements has an inverted polarity, the coupling factors to this particular element will be inverted as well. By suitably decoupling the equivalent inductors L₁₁, L₂₂ and L₃₃ using electronic components the undesirable effects of coupling are substantially reduced and the three inductors can be used independently in the electrical circuit of the magnetic radiator.

Preferably, the electronic component is selected to decouple the radiator elements on the resonant frequency of the radiator. More preferably, the electronic component is selected to decouple the radiator elements over a broad frequency band containing the resonant frequency of the radiator. Depending on the used component, the decoupling circuit may be resonant on a certain frequency, range of frequencies or not resonant at all. In case of a decoupling circuit containing mainly inductive components a non resonant decoupling circuit will be realized. In case of a decoupling circuit containing mainly capacitive components, a resonant decoupling circuit will be realized. The decoupling circuit may also contain a combination of capacitive and inductive components, either in series or parallel or a combination of both to obtain the desired decoupling impedance.

This may be implemented by using a tuneable electronic component which may be tuned in operation for compensating either any drift of the working frequency or a purposeful alteration of the working frequency. This has an advantage that the decoupling can be controlled in a broad band of useful frequencies. Preferably, the radiator elements and the electronic component are arranged on a common printed circuit. This has an advantage of increased durability of the circuit.

In case when the electronic component is arranged tuneable, the printed circuit may comprise suitable control unit and microprocessor for enabling alteration of decoupling as a function of selected frequency in use. Examples of tuneable circuits are mechanically trimmed capacitors and inductors, varicaps or multiple capacitive and/or inductive components with switching elements to alter the total impedance of the decoupling circuit.

These and other aspects of the invention will be further discussed with reference to drawings, wherein like reference signs represent like items.

### BRIEF DESCRIPTION OF THE DRAWINGS

FIG. 1 presents in a schematic way coupling effects arising in a magnetic radiator comprising circuits of radiator elements.

FIG. 2 presents in a schematic way an equivalent electrical circuit for a magnetic radiator comprising three radiator element circuits.

FIG. 3 presents in a schematic way respective equivalent electrical circuits for magnetic radiators comprising three and four radiator element circuits.

FIG. 4 presents the circuits of FIG. 3, wherein electronic component is arranged for decoupling only adjacent radiator elements.

### DETAILED DESCRIPTION

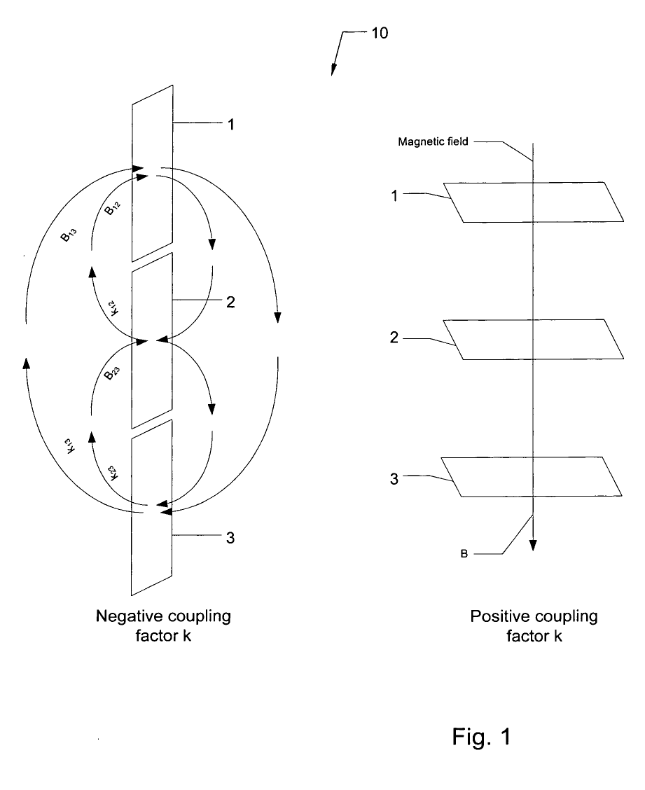

FIG. 1 presents in a schematic way coupling effects arising in a magnetic radiator comprising radiator element circuits. For the sake of simplicity a magnetic radiator having three radiator element circuits is shown. It will be appreciated that the radiator element circuits may be arranged within the magnetic radiator so that either a negative or a positive coupling between the radiator element circuits occurs. Elements 1, 2, 3 represent a setup wherein respective radiator element circuits are negatively coupled, i.e. coupling factors k₁₂, k₂₃, k₁₃ are negative, due to the fact that magnetic fields B₁₂, B₂₃, B₁₃ are counter-aligned. The elements 1′, 2′, 3′, are arranged in such a way that individual magnetic fields (not shown) align resulting in a co-aligned net magnetic field B. In this case the coupling factors k₁₂, k₃, k₁₃ (not indicated) are positive.

It is understood, that if the coupling factor between two certain elements is negative, the equivalent inductance Lᵢⱼ will have a negative value too. To decouple the radiator elements, the inductors Lᵢⱼ, must be made infinitively large which can be done by adding impedance Zᵢⱼ in parallel to Lᵢⱼ. Zᵢⱼ//jωLᵢⱼ=∞ can only be realized when Zᵢⱼ=−jωLᵢⱼ. In particular case where the coupling factor kᵢⱼ is negative, the value of Lᵢⱼ is negative, a suitable value of Zᵢⱼ can thus be realized by adding an electronic component, for example a positive inductor coil equal to |Lᵢⱼ|. If Lᵢⱼ is positive, the same decoupling effect can be realized by adding a capacitor in parallel to this virtual equivalent inductance. Any component with a given complex impedance can be used as long as Z=−Zᵢⱼ at the frequency of interest.

It is further understood that in practice, for small values of kᵢⱼ, the values of the inductors L₁₁, L₂₂ and L₃₃ are equal or close to L₁, L₂ and L₃. Three inductors can be placed between the ports of the radiator elements L₁, L₂ and L₃ thereby effectively decoupling radiator elements of the magnetic radiator by compensating mutual coupling only between adjacent radiator elements. It shall be appreciated that the same approach is applicable for any number of radiator elements constituting a magnetic radiator.

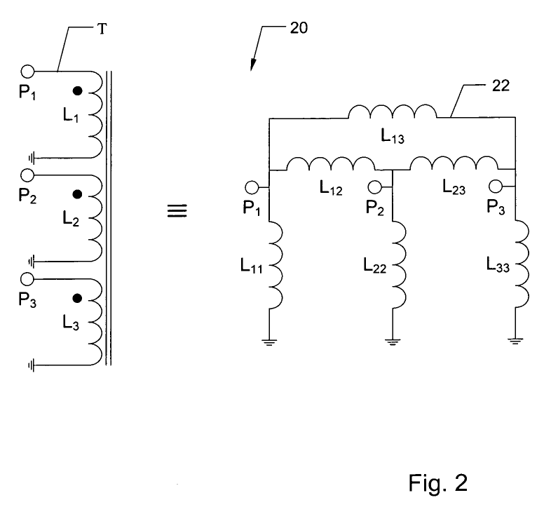

FIG. 2 presents in a schematic way an equivalent electrical circuit 20 for a magnetic radiator comprising three radiator element circuits. The equivalent circuit of a magnetic radiator with multi elements can be seen as an N-port transformer T with a certain coupling factor. If 3 magnetic radiators are used, the equivalent electrical circuit of this transformer with coupling factors k₁₂, k₁₃ and k₂₃ is as shown in FIG. 2, item 22. The corresponding values of the equivalent inductances Lᵢⱼ and Lᵢᵢ are given by:

$${L}_{ij} = ( \frac{1 - {k}_{ij}^{2}}{{k}_{ij}} ) \cdot \sqrt{{L}_{i} {L}_{j}}$$

Lᵢᵢ≈Lᵢ for small values of k₁₂, and k₁₃, or

$${L}_{ii} = \frac{1 - {k}_{itot}^{2}}{{L}_{i}^{- 1} - {k}_{itot} \cdot {L}_{i}^{- 0.5} \cdot {L}_{itot}^{- 0.5}} , where \qquad$$

Lᵢₜₒₜ=(Lᵢ₊₁·Lᵢ₊₂· . . . ·Lₙ)^{1/n-1} is total opposite inductance facing Lᵢ;

kᵢₜₒₜ=1−[(1−kᵢⱼ)·(1−kᵢₖ)· . . . ·(1−kᵢᵢ₊ₙ₋₁)] represent total coupling factors involving Lᵢ.

When the equivalent circuit of the radiator has been defined, a solution for the decoupling problem can be found in the definition of the inductors L₁₂, L₁₃ and L₂₃. For compensating for the decoupling inductances real electric components, like inductances or capacitances can be used, as is described with reference to FIG. 1. In this way the coupling factors kᵢⱼ, which can be either negative or positive depending on the structure of the magnetic radiator, are compensated. Preferably, such compensation is performed only for adjacent radiator element circuits constituting the magnetic radiator.

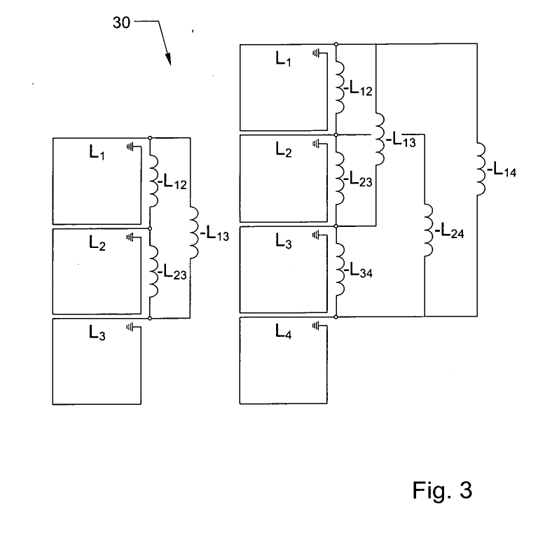

FIG. 3 presents in a schematic view 30 of respective equivalent electrical circuits 31, 32 for magnetic radiators comprising three and four radiator element circuits, respectively. In the equivalent electric circuit 31, mutual coupling between radiator elements is illustrated by electric components −L₁₂, −L₂₃, −L₁₃. As have been explained earlier, equivalent negative inductances may be compensated by using a positive inductive element in the real electrical circuit. In case when the equivalent inductance is positive, it can be compensated by providing a real capacitive element connected in parallel to corresponding portions of the equivalent circuit. In these ways coupling effects are minimized. In the equivalent circuit 32, representing a configuration where four radiator elements are used the following equivalent electronic components (negative inductances) are shown: −L₁₂, −L₂₃, −L₃₄, −L₁₃, −L₂₄, −L₁₄. It will be appreciated that in depicted exemplary embodiments the electronic component necessary to compensate for effects caused by the equivalent electronic components comprised a set of sub-components L₁₂, L₂₃, L₁₃ or L₁₂, L₂₃, L₃₄, L₁₃, L₂₄, L₁₄ for effectively decoupling radiator elements constituting a suitable magnetic radiator.

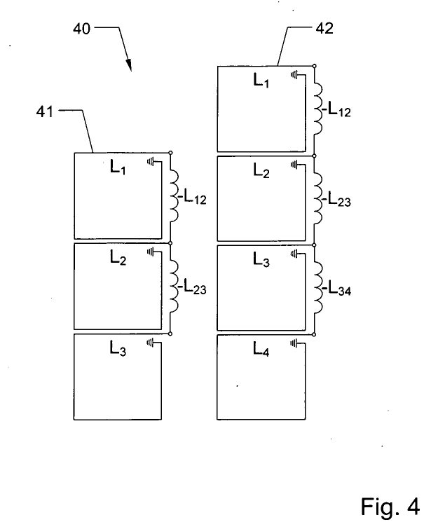

FIG. 4 presents a schematic view 40 of the circuits of FIG. 3, wherein electronic component is arranged for decoupling only adjacent radiator element circuits. Also in this exemplary embodiment the electronic component comprises sub-components −L₁₂, −L₂₃ or −L₁₂, −L₂₃, −L₃₄. The present embodiment is based on the insight that a coupling factor between adjacent radiator elements are substantially larger that the coupling factors between non-adjacent radiator elements. For this reason it is found to be sufficient to substantially mitigate coupling effects in a magnetic resonator comprising a plurality of radiator elements circuits by placing a suitable decoupling electronic component only between adjacent radiator element circuits. Again, equivalent negative inductances may be compensated by using a positive inductive element in the real electrical circuit. In case when the equivalent inductance is positive, it can be compensated by providing a real capacitive element connected in parallel to corresponding portions of the equivalent circuit. In these ways coupling effects are minimized.

While specific embodiments have been described above, it will be appreciated that the invention may be practiced otherwise than as described. The descriptions above are intended to be illustrative, not limiting. Thus, it will be apparent to one skilled in the art that modifications may be made to the invention as described in the foregoing without departing from the scope of the claims set out below.

We claim:

1. A portal article detection means comprising a magnetic radiator (10, 20) provided with a plurality of individual radiator element circuits comprising a plurality of radiator elements (1, 2, 3, L₁, L₂, L₃), said individual radiator element circuits being conceived to individually radiate thereby generating a magnetic field (B), characterized in that
the magnetic radiator further comprises a decoupling circuit comprising an electronic component (−Lᵢⱼ) arranged in electrical connection between said individual radiator element circuits for substantially decoupling the radiator elements (L₁, L₂, L₃) in the same frequency range.

2. A portal article detection means according to claim 1, wherein the electronic component (−Lᵢⱼ) comprises a plurality of sub-components for decoupling at least adjacent radiator elements.

3. A portal article detection means according to claim 1, wherein the electronic component (−Lᵢⱼ) is arranged to decouple the radiator elements for a selected resonance frequency.

4. A portal article detection means according to claim 3, wherein the electronic component is tunable for decoupling the radiator elements for a range of selected resonance frequencies.

5. A portal article detection means according to claim 1, wherein the radiator elements and the electronic element are arranged on a printed circuit.

6. A portal article detection means according to claim 2, wherein the electronic component (−Lᵢⱼ) is arranged to decouple the radiator elements for a selected resonance frequency.
